(19) United States
(12) Patent Application Publication
(10) Pub. No.: US 2012/0299418 A1
(43) Pub. Date: Nov. 29, 2012

(54) Bearing assembly and motor including the same

(75) Inventors: Ki Suk Woo, Seoul (KR); Ju Ho Kim, Seoul (KR); Shin Young Cheong, Seoul (KR); Han Byul Kim, Seoul (KR)

(73) Assignee: SAMSUNG ELECTRO-MECHANICS CO., LTD., Suwon (KR)

(21) Appl. No.: 13/137,289

(22) Filed: Aug. 3, 2011

(30) Foreign Application Priority Data
May 23, 2011 (KR) 10-2011-0048492

(51) Int. Cl. H02K 7/08; F16C 32/04

(52) U.S. Cl. 310/90; 384/119; 384/215

(57) ABSTRACT

There is provided a bearing assembly and a motor including the same, bearing assembly including: a shaft including a first magnet provided thereon; a sleeve including a second magnet provided therein and disposed to face the first magnet so as to support the shaft; and a damping part disposed at a position at which the first and second magnets have maximum magnetic flux density in order to damp vibrations of the first and second magnets.

### CROSS-REFERENCE TO RELATED APPLICATIONS

This application claims the priority of Korean Patent Application No. 10-2011-0048492 filed on May 23, 2011, in the Korean Intellectual Property Office, the disclosure of which is incorporated herein by reference.

### BACKGROUND OF THE INVENTION

1. Field of the Invention

The present invention relates to a bearing assembly and a motor including the same, and more particularly, to a bearing assembly in which damping characteristics for external impact, or the like, are improved, and a motor including the same.

2. Description of the Related Art

A hard disk drive (HDD), an information storage device, reads data stored on a disk or writes data to the disk using a read/write head.

The hard disk drive requires a disk driving device capable of driving the disk. As the disk driving device, a small-sized motor is used.

As the small-sized motor, a hydrodynamic bearing assembly has been used. A shaft, a rotating member of the hydrodynamic bearing assembly, and a sleeve, a fixed member thereof, have oil interposed therebetween, such that the shaft is supported by fluid pressure generated by the oil.

In the motor according to the related art, when a hub, which is a rotating member, rotates, friction due to the oil is generated. The friction increases power consumption for the driving of the motor.

Further, when the motor according to the related art has an external impact applied thereto, the shaft may contact the sleeve. This contact promotes the abrasion of the shaft or of the sleeve to thereby have an adverse effect on a performance of the motor.

Therefore, in the motor capable of driving the disk of the hard disk drive, research into technology for minimizing power consumption for driving the motor and improving damping characteristics for external impacts to thereby maximize a performance and a lifespan of the motor, has been urgently demanded.

### SUMMARY OF THE INVENTION

An aspect of the present invention provides a bearing assembly in which power consumption for driving is minimized, damping characteristics for external impacts, or the like, are improved, and leakage of oil is prevented, and a motor including the same.

According to an aspect of the present invention, there is provided a bearing assembly including: a shaft including a first magnet provided thereon; a sleeve including a second magnet provided therein and disposed to face the first magnet so as to support the shaft; and a damping part disposed at a position at which the first and second magnets have maximum magnetic flux density in order to damp vibrations of the first and second magnets.

The damping part may be made of magnetic fluid.

The damping part may be disposed at at least one of a clearance between the first magnet and the second magnet, a circumference of the first magnet, and a circumference of the second magnet

The first and second magnets may be magnetized in an axial direction or a radial direction.

A clearance between the first magnet and the second magnet may be inclined in an axial direction at a predetermined angle.

An upper surface of the first magnet may have a height equal to or different from that of an upper surface of the second magnet, or a lower surface of the first magnet may have a height equal to or different from that of a lower surface of the second magnet.

The bearing assembly may further include a hydrodynamic part formed formed in at least one of the shaft and the sleeve and providing radial dynamic pressure to the shaft by oil filled between the shaft and the sleeve.

The damping part may be disposed outside an interface of the oil so as to prevent leakage of the oil.

According to another aspect of the present invention, there is provided a motor including: the bearing assembly as described above; a hub rotating together with the shaft having the first magnet coupled thereto; and a base coupled to the sleeve and including a core having a coil wound therearound, the coil generating rotational driving force.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor including a bearing assembly according to an embodiment of the present invention;

FIGS. 2 and 3 are, respectively, a cross-sectional view and a cut-away perspective view schematically showing a modified example of a position of a damping part included in a bearing assembly according to an embodiment of the present invention;

FIG. 4 is a cross-sectional view schematically showing a state in which oil is filled in the bearing assembly of FIG. 2;

FIG. 5 is a cross-sectional view schematically showing a state in which a damping part included in a bearing assembly according to an embodiment of the present invention is disposed between an outer peripheral surface of a second magnet and a main wall part;

FIG. 6 is a cross-sectional view schematically showing a motor including a bearing assembly according to another embodiment of the present invention;

FIGS. 7 and 8 are enlarged views schematically showing a modified example of part A of FIG. 6; and

FIGS. 9 and 10 are cross-sectional views schematically showing a positional relationship between first and second magnets included in a bearing assembly according to the embodiment of the present invention.

### DETAILED DESCRIPTION OF THE PREFERRED EMBODIMENT

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, like reference numerals will be used to designate like components having similar functions throughout the drawings within the scope of the present invention.

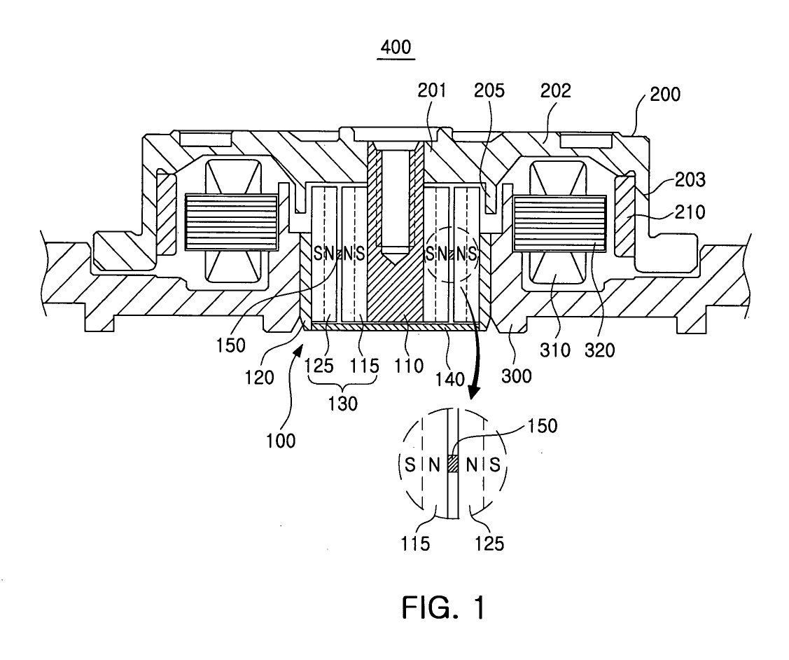

FIG. 1 is a cross-sectional view schematically showing a motor including a bearing assembly according to an embodiment of the present invention.

Referring to FIG. 1, a motor 400 including a bearing assembly 100 according to an embodiment of the present invention may include the bearing assembly 100 including a magnetic bearing 130; a base 300 having a core 320 coupled thereto, the core 320 having a coil 310 wound therearound; and a hub 200 having a driving magnet 210 coupled thereto.

Terms with respect to directions will be first defined. As viewed in FIG. 1, an axial direction refers to a vertical direction based on the shaft 110, and an outer radial or inner radial direction refers to a direction towards an outer edge of the hub 200 based on the shaft 110 or a direction towards the center of the shaft 110 based on the outer edge of the hub 200.

The bearing assembly 100 may include the shaft 110 including a first magnet 115 provided thereon, the sleeve 120 including a second magnet 125 provided therein, and a damping part 150 for damping vibrations.

Hereinafter, the first and second magnets 115 and 125, a component configuring a magnetic bearing 130, in the motor 400 including the bearing assembly 100 according to an embodiment of the present invention, will be described in detail.

The shaft 110, which is a rotating member coupled to the hub 200 rotating to thereby rotate together with the hub 200, may include the first magnet 115 coupled to an outer peripheral surface thereof.

Therefore, the first magnet 115 may function as a rotating magnet of the magnetic bearing 130.

Here, the first magnet 115 may be disposed to face the second magnet 125 coupled to the sleeve 120. Therefore, repulsive force acts between the first and second magnets 115 and 125.

This repulsive force of the outer radial or inner radial direction may stably support the rotation of the shaft 110 having the first magnet 115 coupled thereto and prevent the shaft 100 from being eccentric from the center thereof to thereby improve a performance of the motor 400 according to an embodiment of the present invention.

Here, the first magnet 115 may be magnetized in the radial direction as shown in FIG. 1. However, the first magnet 115 is not limited thereto, and may also be magnetized in the axial direction.

In addition, the first magnet 115 and the shaft 110 may be bonding coupled to each other by applying an adhesive to at least one of an outer peripheral surface of the shaft 110 and an inner peripheral surface of the first magnet 115 and may be maintained in a non-contact state with the first magnet 125 by the adhesive.

Further, simultaneously with, or separately from, the application of the adhesive, the first magnet 115 may also be coupled to the shaft 110 in such a manner as to be press-fitted.

In this case, the inner peripheral surface of the first magnet 115 may have a diameter smaller than that of the outer peripheral surface of the shaft 110.

In addition, although not shown, the outer peripheral surface of the shaft 110 may be formed to be stepped such that the shaft 110 supports a portion of a bottom surface of the first magnet 115, whereby the bottom surface of the first magnet 115 may be seated on the stepped portion to thereby more stably couple the first magnet 115 and the shaft 110 to each other.

The sleeve 120 may include the second magnet 125 provided therein disposed to face the first magnet 115 so as to support the shaft 110. The first and second magnets 115 and 125 may include the repulsive force acting therebetween and configure the magnetic bearing 130.

The magnetic bearing 130 may minimize friction at the time of a rotation of a rotating member including the shaft 110 and the hub 200 to thereby minimize power consumption for rotational driving.

Here, the second magnet 125 may be magnetized in the radial or axial direction, similar to the first magnet 115.

However, when the second magnet 125 is magnetized in the same direction as the direction in which the first magnet 115 is magnetized, the repulsive force between first and second magnets 115 and 125 may be maximized.

A method of coupling the second magnet 125 and the sleeve 120 to each other may be the same as the method of coupling the first magnet 115 and the shaft 110 to each other as described above. An inner peripheral surface of the sleeve 120 may be formed to be stepped to thereby seat a bottom surface of the second magnet 125 thereon.

In addition, since the outer peripheral surface of the sleeve 120 may be coupled to the inner peripheral surface of the base 300, the sleeve 120 may be a fixed member supporting the rotating member including the shaft 110 and the hub 200 together with the base 300.

Here, a lower portion of the sleeve 120 in the axial direction may be closed by the base cover 140, and the base cover 140 may be formed of a member different from the sleeve 120.

However, the base cover 140 may be formed integrally with the sleeve 120 to thereby form a cup shape together with the sleeve 120, of which one side is opened and the other side is closed.

The damping part 150, which is a component for improving damping characteristics for vibrations due to inner or outer oscillations of the motor 400 according to an embodiment of the present invention, may be disposed at a position at which the magnetic bearing 130 has maximum magnetic flux density.

Here, the damping part 150 may be made of magnetic fluid, which is a material reacting to magnetic force by the first and second magnets 115 and 125 configuring the magnetic bearing 130.

The damping part 150 may be disposed at the center of a clearance between the first and second magnets 115 and 125 that are magnetized in the outer radial or inner radial direction, as shown in FIG. 1, which may be a result according to the distribution of the magnetic flux density of the first and second magnets 115 and 125.

That is, when the first and second magnets 115 and 125 are magnetized in the outer radial or inner radial direction, a position at which the maximum magnetic flux density is generated may be the center of the clearance between the first and second magnets 115 and 125. Due to the distribution of the magnetic flux density as described above, the damping part 150 may be naturally disposed at the position in which the maximum magnetic flux density is generated.

Therefore, a final position of the damping part 150 may be changed according to shapes, magnetization directions, and the like, of the first and second magnets 115 and 125 configuring the magnetic bearing 130.

In other words, the position of the damping part 150 may be variously changed according to the distribution of the magnetic flux density of the first and second magnets 115 and 125.

In addition, oil (not shown) may be filled in the clearance between the first and second magnets 115 and 125 configuring the magnetic bearing 130.

Similarly to the function of the damping part 150, the oil may prevent contact between the first and second magnets 115 and 125 due to inner or outer oscillations, or the like, to thereby prevent damages of the first and second magnets 115 and 125.

That is, the oil may be filled up to a lower side of the damping part 150 to thereby serve to absorb impacts due to inner or outer oscillations. As a result, the oil may absorb external impacts together with the damping part 150 for improving the damping characteristics for vibrations to thereby improve the performance of the magnetic bearing 130.

Here, the damping part 150 may be disposed outwardly of the oil, that is, the damping part 150 may be disposed upwardly of the oil to prevent leakage of the oil due to inner or outer oscillations, thereby preventing deterioration in an impact absorption function by the oil.

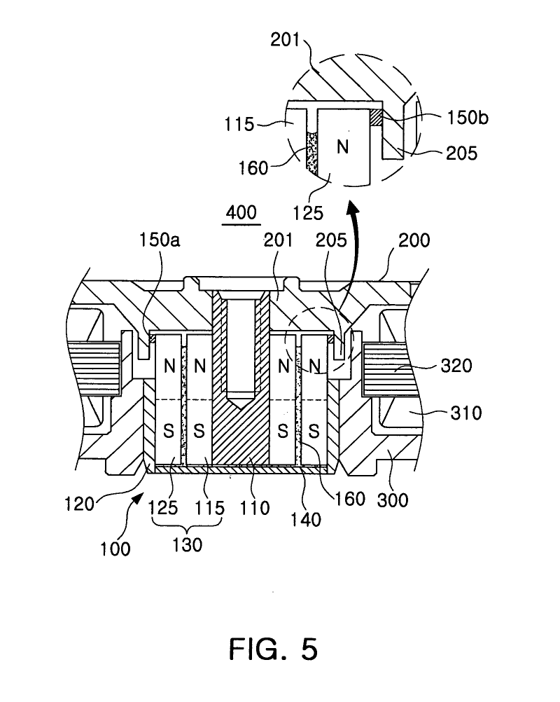

Configurations and functions of the oil will be described in detail below with reference to FIG. 5.

The hub 200 may be a rotating structure rotatably provided with respect to the fixed member including the base 300.

In addition, the hub 200 may include an annular ring-shaped driving magnet 210 provided on an inner peripheral surface thereof, the annular ring-shaped driving magnet 210 corresponding to the core 320, while having a predetermined interval therebetween.

More specifically, the hub 200 may include a first cylindrical wall part 201 fixed to an upper end of the shaft 110, a disk part 202 extended in the outer radial direction from an end portion of the first cylindrical wall part 201, and a second cylindrical wall part 203 protruding axially downwardly from an end portion of the disk part 202 in the outer radial direction.

Here, the driving magnet 210 may be coupled to an inner peripheral surface of the second cylindrical wall part 203. Rotational driving force of the motor 400 according to an embodiment of the present invention may be obtained by electromagnetic interaction between the driving magnet 210 and the coil 310 wound around the core 320.

The base 300 may be the fixed member supporting the rotation of the rotating member including the shaft 110 and the hub 200.

Here, the base 300 may include the core 320 coupled thereto, the core 320 having the coil 310 wound therearound. The core 320 may be fixedly disposed on an upper portion of the base 300 including a printed circuit board (not shown) having circuit patterns printed thereon.

The base 300 may have an outer peripheral surface of the sleeve 120 coupled thereto and the core 320 inserted thereinto and coupled thereto, the core 320 having the coil 310 wound therearound. The base 300 and the outer peripheral surface of the sleeve 120 or the base 300 and the core 320 may be coupled to each other by methods such as a bonding method, a welding method, a press-fitting method, or the like. However, a method of coupling the base 300 and the outer peripheral surface of the sleeve 120 or the base 300 and the core 320 to each other is not necessarily limited thereto.

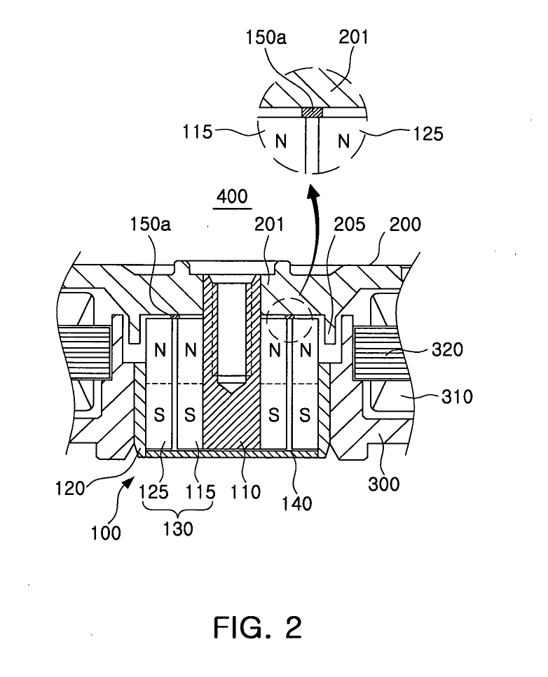

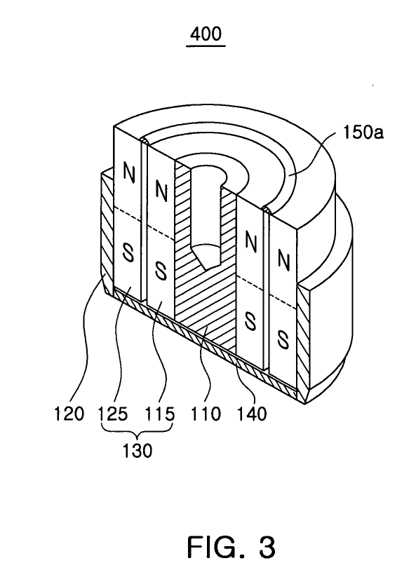

FIGS. 2 and 3 are, respectively, a cross-sectional view and a cut-away perspective view schematically showing a modified example of a position of a damping part included in a bearing assembly according to an embodiment of the present invention.

Referring to FIGS. 2 and 3, the magnetic bearing 130 included in the bearing assembly 100 according to an embodiment of the present invention may include first and second magnets 115 and 125 that are magnetized in the axial direction.

Here, a damping part 150a may be disposed at an upper side of a clearance between the first and second magnets 115 and 125 and be generally disposed in at least one of the circumference of the first magnet 115 and the circumference of the second magnet 125.

In addition, the damping part 150a may contact the bottom surface of the first cylindrical wall part 201 of the hub 200 and be disposed at the position at which the first and second magnets 115 and 125 have maximum magnetic flux density.

Here, the damping part 150a may absorb impacts and vibrations due to inner or outer oscillations to thereby improve damping characteristics and may have a final position changed according to shapes and magnetization directions of the first and second magnets 115 and 125 configuring the magnetic bearing 130.

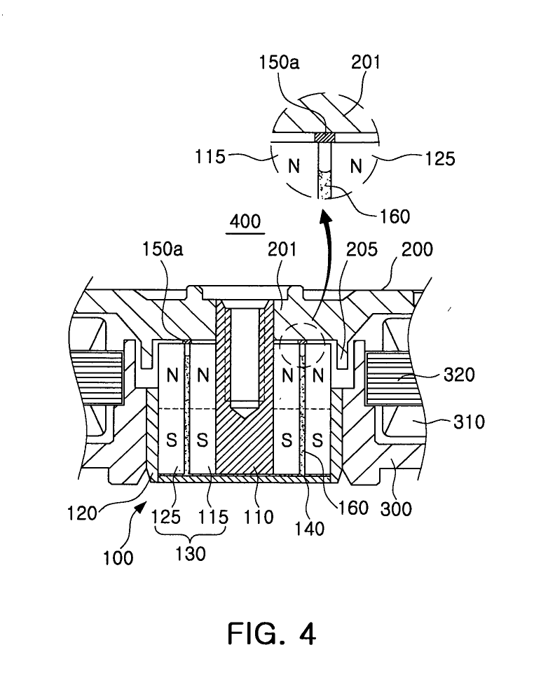

FIG. 4 is a cross-sectional view schematically showing a state in which oil is filled in the bearing assembly of FIG. 2.

Referring to FIG. 4, oil 160 may be filled in the clearance between the first and second magnets 115 and 125 configuring the magnetic bearing 130.

The oil 160, which is an element for improving the performance of the magnetic bearing 130, may serve as a second damping part that absorbs impacts due to inner or outer oscillations, together with the damping part 150a.

The first and second magnets 115 and 125 configuring the magnetic bearing 130 may be generally made of a sintered material, which may lead to fragility in the first and second magnets 115 and 125.

Therefore, when the first magnet 115 contacts the second magnet 125 by impacts due to inner or outer oscillations, cracks may be generated in the first and second magnets 115 and 125. As a result, the first and second magnets may be damaged.

The above-mentioned defect may be solved by the use of the damping part 150a and be more effectively solved by an impact absorption function of the oil 160.

In addition, the oil 160 may be filled up to a lower side of the damping part 150a, which may minimize the possibility of leakage of the oil 160.

In other words, the damping part 150a made of a material such as magnetic fluid, or the like, may seal the oil 160 filled in the clearance between the first and second magnets 115 and 125 to thereby block the oil 160 from the outside.

Therefore, the damping part 150a may allow the oil 160 to be sealed to thereby prevent the oil 160 from being leaked.

FIG. 5 is a cross-sectional view schematically showing a state in which a damping part included in a bearing assembly according to an embodiment of the present invention is disposed between an outer peripheral surface of a second magnet and a main wall part.

Referring to FIG. 5, the hub 200 included in the bearing assembly 100 according to an embodiment of the present invention may include a wall part 205 protruding downwardly in the axial direction.

In this configuration, a damping part 150b may be disposed between the wall part 205 and an outer peripheral surface of the second magnet 125, and block the oil 160 from the outside simultaneously with damping impacts due to inner or outer oscillations.

Therefore, the damping part 150b may allow for the sealing of the oil 160 to thereby prevent the damage of the first and second magnets 115 and 125 configuring the magnetic bearing 130.

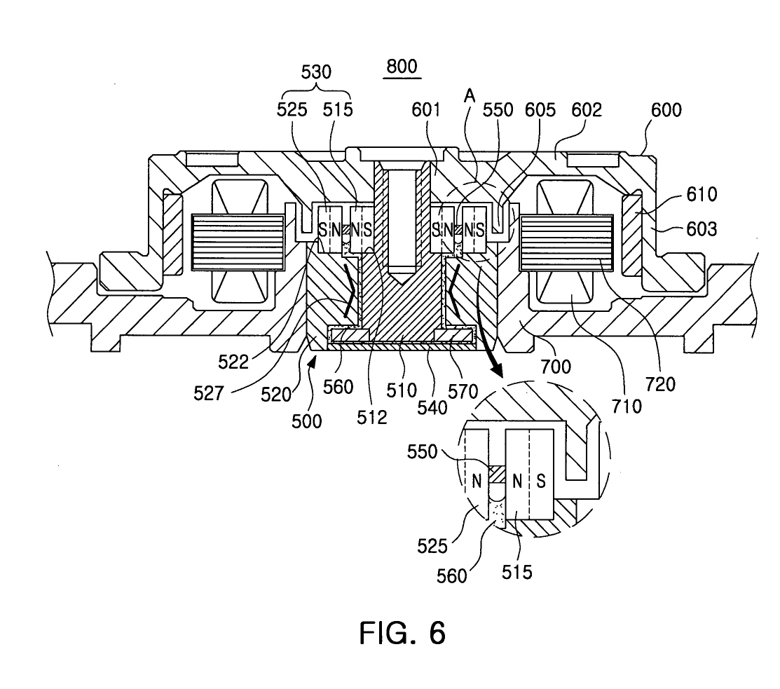

FIG. 6 is a cross-sectional view schematically showing a motor 800 including a bearing assembly 500 according to another embodiment of the present invention.

Referring to FIG. 6, a hub 600, a driving magnet 610, a base 700, a coil 710, and a core 720, which are components of a motor 800 including a bearing assembly 500 according to another embodiment of the present invention have the same configuration and effect as those of the hub 200, the driving magnet 210, the base 300, the coil 310, and the core 320, which are components of the motor 400 including a bearing assembly 100 according to the embodiment of the present invention. Therefore, a description thereof will be omitted.

The motor 800 according to another embodiment of the present invention may include a magnetic bearing 530 and a hydrodynamic part 527 simultaneously formed at upper and lower sides thereof, respectively.

Here, the magnetic bearing 530 may include all of the components of the magnetic bearing 130 including the first and second magnets 115 and 125, with reference to FIGS. 1 through 5 and be different from the magnetic bearing 130 only in a coupling method thereof.

That is, a first magnet 515 may be seated on a reception part 512 formed to be stepped on an outer peripheral surface of the shaft 510. More specifically, a bottom surface of the first magnet 515 may be coupled to the reception part 512.

Therefore, the first magnet 515 may be more firmly coupled to the shaft 510, and a coupling area between the first magnet 515 and the shaft 510 may be increased to thereby allow for further improvements in unmating force of the first magnet 515.

Here, the sleeve 520 may include a seating part 522 supporting an outer peripheral surface and a bottom surface of a second magnet 525. Due to the seating part 522, adhesion between the sleeve 520 and the second magnet 525 may be increased.

The hydrodynamic part 527 may configure a hydrodynamic bearing and generate radial dynamic pressure by oil 560 to thereby support the rotation of the shaft 510.

The hydrodynamic part 527 may be formed in at least one of the shaft 510 and the sleeve 520 that are positioned under the magnetic bearing 530.

In addition, the hydrodynamic part 527 may more smoothly support the rotation of the shaft 510 by the oil 560 filled in a clearance between the shaft 510 and the sleeve 520.

That is, the hydrodynamic part 527 may be formed as a groove having at least one of a herringbone shape, a spiral shape, and a helical shape. However, the hydrodynamic part 527 is not limited to having the above-mentioned shapes but may have any shape as long as the radial dynamic pressure may be generated in the shaft 510.

Here, summing up the bearing included in the motor 800 according to another embodiment of the present invention, the bearing may include the magnetic bearing 530 including the first and second magnets 515 and 525 and the hydrodynamic bearing generating the radial dynamic pressure by the hydrodynamic part 527. As a result, the bearing may be configured to be a hybrid bearing.

In addition, a thrust dynamic pressure part (not shown) may be formed under the hydrodynamic part 527.

More specifically, the thrust dynamic pressure part (not shown) may be formed on at least one of upper and lower surfaces of a thrust plate 570 formed at a lower side of the shaft 510, a lower surface of the sleeve 520 corresponding to the upper surface of the thrust plate 570, and an upper surface of a base cover 540 corresponding to the lower surface of the thrust plate 570.

The trust dynamic pressure part (not shown) may be formed as a groove having at least one of a herringbone shape, a spiral shape, and a helical shape, similar to the hydrodynamic part 527. However, the thrust dynamic pressure part is not limited to having the above-mentioned shape but may have any shape as long as strength and damping effects in the axial direction may be increased by thrust dynamic pressure of the oil 560.

Here, the oil 560 allowing the hydrodynamic part 527 to generate the radial dynamic pressure may be filled up to a clearance between the first and second magnets 515 and 525 configuring the magnetic bearing 530, and an interface of the oil 560 may be formed between the first and second magnets 515 and 525.

However, the interface of the oil 560 is not limited to being formed between the first and second magnets 515 and 525 but may also be formed under lower surfaces and the first and second magnets 515 and 525.

Here, the damping part 550 may be made of magnetic fluid reacting to magnetic force of the first and second magnets 515 and 525 of the magnetic bearing 530 and be disposed at the center of the clearance between the first and second magnets 515 and 525.

The damping part 550 may be disposed at a position at which the first and second magnets 515 and 525 have the maximum magnetic flux density and have a final position changed according to the shapes, the magnetization directions, and the like, of the first and second magnets 515 and 525, as described with reference to FIGS. 1 through 5.

In addition, the damping part 550 may be disposed outside the interface of the oil 560 to seal the oil 560 and improve the damping characteristics for impacts due to inner or outer oscillations to thereby maximize a performance of the magnetic bearing 530.

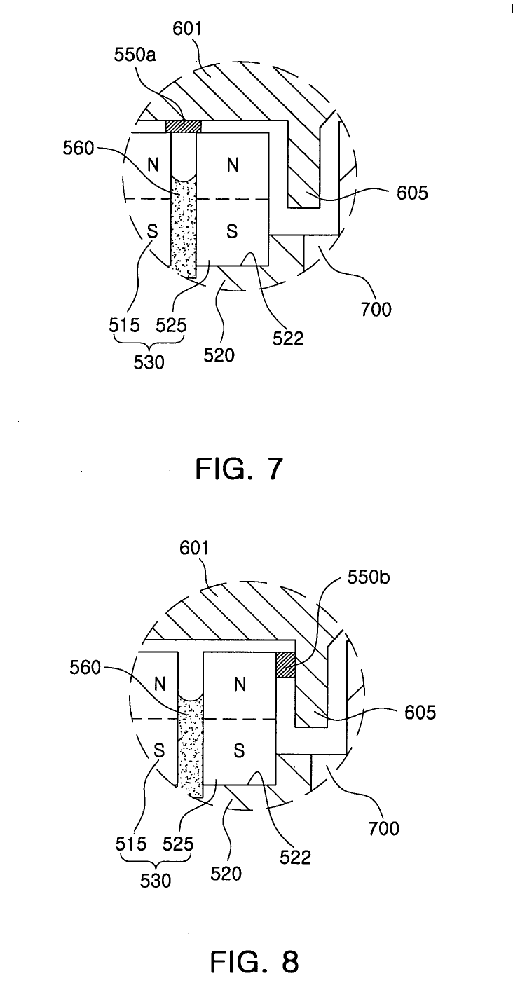

FIGS. 7 and 8 are enlarged views schematically showing a modified example of part A of FIG. 6.

Referring to FIG. 7, the magnetic bearing 530 included in the bearing assembly 500 according to an embodiment of the present invention may include first and second magnets 515 and 525 that are magnetized in the axial direction.

Here, a damping part 550a may be disposed at an upper side of a clearance between the first and second magnets 515 and 525 and be generally disposed at any one of the circumference of the first magnet 515 and the circumference of the second magnet 525.

In addition, the damping part 550a may contact a bottom surface of a first cylindrical wall part 601 of the hub 600 and be disposed at the position at which the first and second magnets 515 and 525 have maximum magnetic flux density.

Here, the damping part 550a may absorb impacts and vibrations due to the inner and outer oscillation to thereby improve the damping characteristics and may have a final position changed according to shapes and magnetization directions of the first and second magnets 515 and 525 configuring the magnetic bearing 530.

Referring to FIG. 8, a damping part 550b may be disposed between a wall part 605 and an outer peripheral surface of the second magnet 525, and block the oil 560 from the outside simultaneously with damping impacts due to inner or outer oscillations.

Therefore, the damping part 550b may allow for the sealing of the oil 560 to thereby prevent damage to the first and second magnets 515 and 525 configuring the magnetic bearing 530.

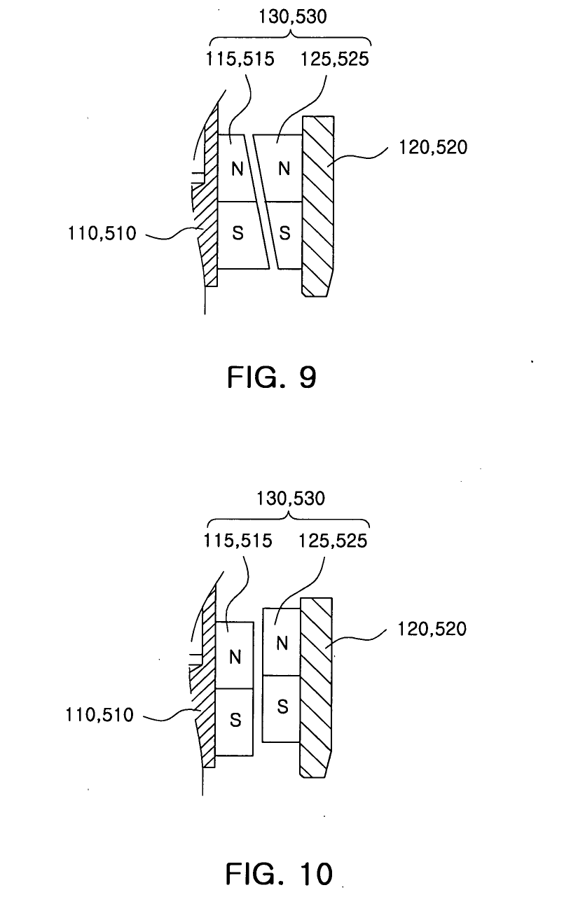

FIGS. 9 and 10 are cross-sectional views schematically showing a positional relationship between first and second magnets included in a bearing assembly according to the present invention.

Referring to FIG. 9, a clearance between the first magnet 115 or 515 and the second magnet 125 or 525 configuring the magnetic bearing 130 or 530 in the motors 400 or 800 according to the embodiments of the present invention may be inclined in the axial direction at a predetermined angle.

However, although FIG. 9 shows a case in which the clearance is inclined in the inner radial direction from a lower side thereof toward an upper side thereof, the clearance is not limited to being inclined in the above-mentioned direction but may also be inclined in the outer radial direction.

In addition, as described above, this feature may also be applied to a case in which the first magnets 115 or 515 and the second magnet 125 and 525 are magnetized in the radial direction.

Referring to FIG. 10, upper surfaces of the first magnet 115 or 515 and the second magnet 125 or 525 configuring the magnetic bearing 130 or 530 in the motors 400 or 800 according to the embodiments of the present invention may be inclined in the axial direction at a predetermined angle may be offset.

That is, as shown in FIG. 10, the upper surface of the second magnet 125 or 525 may have a height higher than that of the upper surface of the first magnet 115 or 515, and vice versa.

In addition, the upper surface of the first magnet 115 or 515 may have a height higher than that of the upper surface of the second magnet 125 or 525 and a lower surface of the first magnet 115 or 515 may have a height lower than that of a lower surface of the second magnet 125 or 525, and vice versa.

Additionally, all of these features may also be applied to a case in which the first magnets 115 or 515 and the second magnet 125 and 525 are magnetized in the radial direction.

A positional relationship between the first magnet 115 or 515 and the second magnet 125 or 525 as described above may allow the repulsive force to be generated in the axial direction as well as in the outer radial or inner radial direction between the first magnet 115 or 515 and the second magnet 125 and 525, thereby preventing the rotating member including the shaft 110 or 510 from being excessively floated.

Through the embodiments as described above, in the motor 400 or 800 according to the present invention, the damping part 150, 150a, 150b, 550, 550a, or 550b made of the magnetic fluid is disposed at the position at which the first magnet 115 or 515 and the second magnet 125 or 525 configuring the magnetic bearing 130 or 530 have the maximum magnetic flux field, whereby the damping characteristics for impacts due to inner or outer oscillations may be improved.

In addition, the damping part 150, 150a, 150b, 550, 550a, or 550b enhances the sealing of the oil 160 or 560, whereby the leakage of the oil 160 or 560 may be prevented.

As set forth above, with the bearing assembly and the motor including the same according to the embodiments of the present invention, power consumption for driving may be minimized and damping characteristics for external impacts, or the like, may be maximized.

In addition, the leakage of the oil may be prevented, whereby dynamic pressure generation and impact absorption functions by the oil may be maximized.

While the present invention has been shown and described in connection with the embodiments, it will be apparent to those skilled in the art that modifications and variations can be made without departing from the spirit and scope of the invention as defined by the appended claims.

What is claimed is:

1. A bearing assembly comprising:
a shaft including a first magnet provided thereon;
a sleeve including a second magnet provided therein and disposed to face the first magnet so as to support the shaft; and
a damping part disposed at a position at which the first and second magnets have maximum magnetic flux density in order to damp vibrations of the first and second magnets.

2. The bearing assembly of claim 1, wherein the damping part is made of magnetic fluid.

3. The bearing assembly of claim 1, wherein the damping part is disposed at at least one of a clearance between the first magnet and the second magnet, a circumference of the first magnet, and a circumference of the second magnet.

4. The bearing assembly of claim 1, wherein the first and second magnets are magnetized in an axial direction or a radial direction.

5. The bearing assembly of claim 1, wherein a clearance between the first magnet and the second magnet is inclined in an axial direction at a predetermined angle.

6. The bearing assembly of claim 1, wherein an upper surface of the first magnet has a height equal to or different from that of an upper surface of the second magnet, or a lower surface of the first magnet has a height equal to or different from that of a lower surface of the second magnet.

7. The bearing assembly of claim 1, further comprising a hydrodynamic part formed in at least one of the shaft and the sleeve and providing radial dynamic pressure to the shaft by oil filled between the shaft and the sleeve.

8. The bearing assembly of claim 7, wherein the damping part is disposed outside an interface of the oil so as to prevent leakage of the oil.

9. A motor comprising:
the bearing assembly of claim 1;
a hub rotating together with the shaft having the first magnet coupled thereto; and
a base coupled to the sleeve and including a core having a coil wound therearound, the coil generating rotational driving force.
